(19) United States
(12) Patent Application Publication
(10) Pub. No.: US 2005/0013966 A1
(43) Pub. Date: Jan. 20, 2005

(54) Optical recording medium for fluorescent WORM discs

(76) Inventors: Mark Alperovich, Ashdod (IL); Eugene Levich, New York, NY (US); Irene Zuhl, Ashdod (IL); Khaihln A., Holon (IL)

Correspondence Address: BLANK ROME LLP, 600 NEW HAMPSHIRE AVENUE, N.W., WASHINGTON, DC, 20037, US

(21) Appl. No.: 10/917,384

(22) Filed: Aug. 13, 2004

Related U.S. Application Data
(63) Continuation of application No. 09/493,267, filed on Jan. 28, 2000, now abandoned.
(60) Provisional application No. 60/119,901, filed on Feb. 12, 1999.

(51) Int. Cl. B32B 3/02

(52) U.S. Cl. 428/64.4

(57) ABSTRACT

An optical recording medium for fluorescent WORM discs comprising a fluorescent dye, nitrocellulose and film-forming polymer is disclosed. The medium provides a high capacity optical memory for WORM discs, including 3-dimensional optical memory systems.

### FIELD OF THE INVENTION

This invention is in the field of media for WORM optical discs with fluorescent reading, providing high capacity optical memory, including 3-dimensional optical memory systems.

### BACKGROUND OF THE INVENTION

Recently WORM optical memory devices have experienced great evolution, providing recording of data with the possibility of its immediate reading. This feature—data recording in a real-time regime—is significant for various applications of optical recording in memory devices, especially for computer systems. For this field duplication of data is not so essential.

All WORM optical media of practical interest is based on photothermal principle of recording [1]. The data on such media is recorded by scanning the recording layer with the focused laser beam. The laser power is absorbed by the active medium of the layer and transformed into thermal energy, causing its physical and chemical changes, which can be optically registered at reading.

Photochemical effects can also be used, i.e. optically detected changes in the state of medium, caused by direct interaction of photons with this medium. The efforts are made to use photosensitive medium for photochemical recording on WORM discs. Hence, until now there was no practical application for WORM discs with photon mechanism of recording. The reason can be the non-threshold nature of photochemical recording on the contrary to photothermal recording at the same laser for recording and reading (with different laser power). Therefore, the photochemical recording can not provide the necessary stability of medium characteristics at multiple reading.

According to the mechanisms of thermally induced effects, the photothermal recording on WORM optical medium with practical applications can be divided in two parts:
1. Ablative, providing optically registered geometric changes in the thin active layer during its melting, evaporation or chemical transformations, and
2. With phase change, which does not provide geometric changing of the active layer, otherwise changing its optical constants, that causes optical contrast, which is usually not high for these materials.

Among various types of medium for ablative recording, WORM optical discs with thin (10-100 nm) layers of organic dyes with or without dye-in-polymer are of special interest. Layers of organic dyes provide a range of sufficient advantages in comparison to metal or half-metal layers, used in WORM discs with ablative recording. Advantages are the following:
Dyes may have a stronger selective absorption on the recording laser wavelength.
Dye layers are more sensitive to the laser radiation because of their small thermal conductivity and low temperature of melting or decomposition. It provides a higher recording capacity.
Dye layers provide a higher stability at higher humidity.
Medium based on dye layers has better signal-to-noise ratio, because of the lack of noise, provided by amorphous layers.
Coating in the centrifuge makes the layers, that is more simple and cheap than vacuum deposition used for obtaining metal and half-metal layers on WORM discs.

The existing WORM optical discs based on organic dyes has a capacity up to 3.5 GB.

The WORM discs with one recording layer this optical memory capacity is the utmost at least for the diode laser with 780-830 nm wavelength.

Future capacity increase for WORM discs is possible only using three-dimensional optical memory carriers with multilayer data recording and fluorescent reading [2, 3].

Fluorescent reading offers a range of sufficient advantages in comparison to reading, based on changing the reflection ratio, even in single-layer systems.

One of the advantages is the reduced tolerance for the sizes of recorded pits in comparison to the existing WORM discs. For example, changing the size on a hundred nm does not influence the reading from fluorescent disc, while it totally eliminates the signal from reflective discs.

Another advantage is the reduced sensitivity of fluorescent discs to changing the slope up to one grad that is absolutely intolerable for reflective discs.

Nevertheless, the basic advantage of fluorescent reading is its most fitness for three-dimensional optical memory carriers, i.e. multilayer discs.

Use of layers of organic dyes in such medium is not possible owing to the following reasons:
Reading is realized by laser beam, scanning the change of reflection in the pre-irradiated spots. In a multilayer system, this method causes a strong fall of reading quality, becoming dramatic for systems with over four active layers.
Heat change of the layer geometrical structure at recording, such as: burning out of holes, creation of bubbles, change of surface texture, etc. It is also unsuitable for multilayer medium, as it causes dispersion of the reading beam, hence abruptly lowering the detection quality.
The dye concentration in the recording layer of the existing WORM discs is the utmost (up to 99%). In this case, the dye fluorescence is usually suppressed because of high concentration.

In the thin dye layers (10-100 nm) of the existing WORM discs, the local heating of the medium at recording can reach 700° C. Such high temperature make it difficult to avoid changing the geometrical structure of the layer. Increase of the dye layer thickness up to 200 nm and more using polymer dye at preserving the surface concentration of dye leads to lowering the local heating temperature and allows to prevent the layer deformation. It also provides the appearance and growth of the dye fluorescence thanks to lowering the concentration suppression effect. However at all the same conditions the layer sensitivity to laser radiation is dramatically lowering, that leads to drop of recording speed and density.

Thus, all the known materials, used for single-layer optical WORM discs with reflective reading, as well as photothermal recording methods can not be used for multilayer optical WORM discs with fluorescent reading. Comparatively thick layers (200 nm and more), containing fluorescent dyes, are also not likely suitable for multilayer medium creation without use of special ways and additives, providing increase in recording speed and density.

### SUMMARY OF THE INVENTION

Considering the above-stated, the purpose of this Invention is the obtaining of a high-sensitive dye-in-polymer (DIP) medium for fluorescent WORM discs, providing high rates and density of photothermal recording.

The other purpose of the present Invention is the obtaining of a DIP media with high sensitivity to the recording laser radiation in visual and infrared ranges.

The future purpose of the present Invention is the obtaining of DIP media for single- and multilayer materials with high optical memory capacity, high resolution and high darkness and radiation stability.

According to the purpose of this Invention, the above-stated DIP media contains a fluorescent dye, capable to absorb the recording laser radiation and transform the absorbed light power into heat, and nitrocellulose, capable to generate decomposition products under heating.

According to the other purpose of the present Invention, the above-stated DIP media contains a fluorescent dye, which generates non-fluorescent dimers with sandwich structure, capable to absorb the recording laser radiation and transform it into heat, and nitrocellulose, capable to generate decomposition products under heating.

According to the future purpose of the present Invention, the above-mentioned nitrocellulose decomposition' products cause the distinguishing of fluorescence or discoloring of the fluorescent dye, thus making the recording.

If the recording laser radiation is absorbed by the monomer form of fluorescent dye, the same laser can be used for reading and recording (i.e., 650 nm, but with different pulse power). If the recording laser radiation is absorbed by the dimer form of fluorescent dye, the recording laser has shorter wavelength (i.e., 635 nm).

### DETAILED DESCRIPTION OF THE PREFERRED EMBODIMENTS

Below there is a detailed description of the mostly preferred ways to reach the intended purposes of the Invention.

First we shall consider the variant when the substrate—a transparent disc from glass, polymethylmethacrylate, polycarbonate or polyethylene terephthalate—is covered with a recording layer, consisting at least of a fluorescent dye, capable to absorb the recording laser radiation and transform it into heat, nitrocellulose, capable to generate decomposition products under heating, which discolor the dye or extinguish its fluorescence, and a film-forming polymer with high transparency, low heat conductivity and capable to provide the necessary quantum output of the dye fluorescence.

Besides, the recording layer can contain compounds, impeding nitrocellulose decomposition, improving the dye stability at disc storage and reading, plastifiers, etc. The thickness of recording layer can be 100-1000 nm, preferably—200-500 nm. Fluorescent dye with maximum absorption value near the recording laser wavelength is chosen among the xanthene dyes of the eosine and rhodamine groups, acridine, oxazine, azine, perylene, violanthrole, cyanine, phthalocyanine dyes, indigoid colors and porphyrines. The content of fluorescent dye in the layer is equal to 0.1-10%.

The offered in the present invention Optical recording composition contains nitrocellulose with 10.7 up to 12.5% nitrogen and polymerization rate (number of eterificated glucose residua in nitrocellulose macromolcule) within 150-300, the so-called lacquer collodion cotton.

At the temperature above 80° C. lacquer collodion cotton decomposes spontaneously, at that the decomposition rate grows quickly at raising temperatures. The lacquer collodion cotton decomposition is a self-accelerating process. The self-acceleration is especially significant in the presence of oxygen and traces of humidity [4].

The film-forming polymer is selected from a wide range of resins, such as: cellulose esters, i.e. nitrocellulose, cellulose acetate, cellulose acetate butyrate; cellulose ethers, i.e. methyl cellulose, ethyl cellulose, butyl cellulose; vinyl resins, i.e. polyvinyl acetate, polyvinyl butyral, polyvinyl acetyl, polyvinyl alcohol and polyvinyl pyrrolidon; acrylic resins, i.e. polymethylmethacrylate, polybutyl acrylate, polymethacrylic acid, polyacrylamide polyacrylonitrile.

But the most preferable are alkyd, urea-formaldehyde and melamine-formaldehyde resins, simple polyvinyl ethers and polyacrylic resins.

Aliphatic, aromatic and heterocyclic amines, urea derivatives, or sulfur compounds can serve for nitrocellulose decomposition impeding.

Film-forming properties of the used resins and the plasticity of the recording layer can be improved by adding to resins the proper plastifier, such as dibutyl phthalate, dioctyl phthalate or tricresyl phosphate.

To create a recording layer of the present Invention, the above-mentioned ingredients are dissolved in organic solvent or introduced in it as microcapsules less than 0.2 mkm in size, prepared by known methods, with future covering the substrate with this compound by spin coating, roller coating or dip coating.

The organic solvent is usually selected from alcohols, ketones, amides, sulfoxides, ethers, esters, halogenated aliphatic hydrocarbons or aromatic solvents. Examples of such solvents include methanol, ethanol, iso-propanol, iso-butanol, tetrafluoro-ethanol, diacetone alcohol, methyl cellosolve, ethyl cellosolve, acetone, methylethylketone, cyclohexanone, N,N-dimethhylformamide, N,N-dimethylacetamide, dimethylsulfoxide, tetrahydrofurane, dioxane, ethyl acetate, chloroform, methylene chloride, dichloroethane, toluene, xylene or their mixtures. In the other variant of realizing of this Invention the fluorescent dye of the Optical recording media forms non-fluorescent dimers of sandwich structure with the maximum absorption value close to the recording laser wavelength. At recording, the non-fluorescent dimers absorb the laser radiation and transform it into heat, which cause determination of nitrocellulose. Its determination products lead to fluorescence distinguishing or decoloration of the dye monomer form.

The advantage of this variant is that non-fluorescent dimers practically fully transfer the absorbed light power into heat, while the fluorescent monomer form realize it only partly. In this case, as stated above, the lasers with different wavelength are used for reading and recording. In the present Invention the single recording layer is either disposed directly on the substrate, or there is an intermediate layer between the substrate and the recording layer to improve adhesion and mechanical durability and lower heat losses due to heat distribution in the substrate. Besides, the use of intermediate layer allows use of solvents, aggressive to the substrate. The recording layer can be covered with a protective layer or with another glued substrate to protect it from outer impacts, thus improving its stability.

In the present Invention, a multilayer disc for three-dimensional optical memory with fluorescent reading is obtained by consecutive bonding of the above single-layer discs one to another so that the active recording layers alternate the inactive separating layers of substrate. The glues used for obtaining a multilayer optical disc shall provide good adhesion of the bonded surfaces and no contraction, which do not worsen the characteristics of recording layers and signal-to-noise ratio, which are transparent for the laser wavelength and fluorescent light. Examples of such glues include UV-hardened optical glues of 3-92, UV-71, UV-69, UV-74, J-91, VTC-2, SK-9 types (“Catalog of Summers laboratories”).

Consecutive scanning of every recording layer by a focused laser beam makes the data recording on a multilayer disc. The same way the reading is made.

### EXAMPLE 1

To obtain the recording layer medium we prepared the ethanol and ethyl cellosolve mixture solution (1:1), containing 1% nitrocellulose, 0.013% oxazine 725 perchlorate (Exiton, Inc.) and dioctylphthalate 0.2%. The compound solvent was filtered, deposited on a polycarbonate disc and dried to form a recording layer with 500 nm thickness.

### EXAMPLE 2

To obtain the recording layer medium we prepared the ethanol and ethyl cellosolve mixture solution (1:1), containing 1% nitrocellulose, 0.039% oxazine 725 perchlorate (Exiton, Inc.) and dioctylphthalate 0.2%. The compound solvent was filtered, deposited on a polycarbonate disc and dried to form a recording layer with 300 nm thickness.

### EXAMPLE 3

To obtain the recording layer medium we prepared the ethanol and ethyl cellosolve mixture solution (1:1), containing 1% nitrocellulose, 0.078% oxazine 725 perchlorate (Exiton, Inc.) and dioctylphthalate 0.2%. The compound solvent was filtered, deposited on a polycarbonate disc and dried to form a recording layer with 200 nm thickness.

### EXAMPLE 4

To obtain the recording layer medium we prepared the ethanol and ethyl cellosolve mixture solution (1:1), containing 1% nitrocellulose, 0.013% HIDC (Exiton, Inc.) and dioctylphthalate 0.2%. The compound solvent was filtered, deposited on a polycarbonate disc and dried to form a recording layer with 500 nm thickness.

### EXAMPLE 5

To obtain the recording layer medium we prepared the ethanol and ethyl cellosolve mixture solution (1:1), containing 1% nitrocellulose, 0.039% HIDC (Exiton, Inc.) and dioctylphthalate 0.2%. The compound solvent was filtered, deposited on a polycarbonate disc and dried to form a recording layer with 300 nm thickness.

### EXAMPLE 6

To obtain the recording layer medium we prepared the ethanol and ethyl cellosolve mixture solution (1:1), containing 1% nitrocellulose, 0.078% HIDC (Exiton, Inc.) and dioctylphthalate 0.2%. The compound solvent was filtered, deposited on a polycarbonate disc and dried to form a recording layer with 300 nm thickness.

### EXAMPLE 7

To obtain the recording layer medium we prepared the ethanol and ethyl cellosolve mixture solution (1:1), containing 1% nitrocellulose, 0.013% 3,3,3′3′ tetramethyl-1,1′-diphenylindodicarbocyanine perchlorate and dioctylphthalate 0.2%. The compound solvent was filtered, deposited on a polycarbonate disc and dried to form a recording layer with 500 nm thickness.

### EXAMPLE 8

To obtain the recording layer medium we prepared the ethanol and ethyl cellosolve mixture solution (1:1), containing 1% nitrocellulose, 0.039% 3,3,3′3′ tetramethyl-1,1′-diphenylindodicarbocyanine perchlorate and dioctylphthalate 0.2%. The compound solvent was filtered, deposited on a polycarbonate disc and dried to form a recording layer with 400 nm thickness.

### EXAMPLE 9

To obtain the recording layer medium we prepared the ethanol and ethyl cellosolve mixture solution (1:1), containing 1% nitrocellulose, 0.078% 3,3,3′3′ tetramethyl-1,1′-diphenylindodicarbocyanine perchlorate and dioctylphthalate 0.2%. The compound solvent was filtered, deposited on a polycarbonate disc and dried to form a recording layer with 400 nm thickness.

### EXAMPLE 10

To obtain the recording layer medium we prepared the ethanol and ethyl cellosolve mixture solution (1:1), containing 1% nitrocellulose, 0.013% 3,3,3′3′tetramethyl-1,1′-dibuthyl-4,4,4′,5′-dibenzoindo-dicarbocyanine perchlorate and dioctylphthalate 0.2%. The compound solvent was filtered, deposited on a polycarbonate disc and dried to form a recording layer with 500 nm thickness.

### EXAMPLE 11

To obtain the recording layer medium we prepared the ethanol and ethyl cellosolve mixture solution (1:1), containing 1% nitrocellulose, 0.039% 3,3,3′3′tetramethyl-1,1′-dibuthyl-4,4,4′,5′-dibenzoindo-dicarbocyanine perchlorate and dioctylphthalate 0.2%. The compound solvent was filtered, deposited on a polycarbonate disc and dried to form a recording layer with 300 nm thickness.

### EXAMPLE 12

To obtain the recording layer medium we prepared the ethanol and ethyl cellosolve mixture solution (1:1), containing 1% nitrocellulose, 0.078% 3,3,3′3′tetramethyl-1,1′-dibuthyl-4,4,4′,5′-dibenzoindo-dicarbocyanine perchlorate and dioctylphthalate 0.2%. The compound solvent was filtered, deposited on a polycarbonate disc and dried to form a recording layer with 200 nm thickness.

### EXAMPLE 13

To obtain the recording layer medium we prepared the ethanol and ethyl cellosolve mixture solution (1:1), containing 1% nitrocellulose, 0.013% Triethylammonium salt 1,1-di-γ-sulfopropyl-3,3,3′3′tetramethylindodicarbocyanine and dioctylphthalate 0.2%. The compound solvent was filtered, deposited on a polycarbonate disc and dried to form a recording layer with 500 nm thickness.

### EXAMPLE 14

To obtain the recording layer medium we prepared the ethanol and ethyl cellosolve mixture solution (1:1), containing 1% nitrocellulose, 0.039% Triethylammonium salt 1,1-di-γ-sulfopropyl-3,3,3′3′tetramethylindodicarbocyanine and dioctylphthalate 0.2%. The compound solvent was filtered, deposited on a polycarbonate disc and dried to form a recording layer with 300 nm thickness.

### EXAMPLE 15

To obtain the recording layer medium we prepared the ethanol and ethyl cellosolve mixture solution (1:1), containing 1% nitrocellulose, 0.078% Triethylammonium salt 1,1-di-γ-sulfopropyl-3,3,3′3′tetramethylindodicarbocyanine and dioctylphthalate 0.2%. The compound solvent was filtered, deposited on a polycarbonate disc and dried to form a recording layer with 300 nm thickness.

### EXAMPLE 16

To obtain the recording layer medium we prepared the ethanol and ethyl cellosolve mixture solution (1:1), containing 1% nitrocellulose, 0.013% 3,3,3′3′tetramethyl-1,1′-diphenylindotricarbocyanine perchlorate and dioctylphthalate 0.2%. The compound solvent was filtered, deposited on a polycarbonate disc and dried to form a recording layer with 300 nm thickness.

### EXAMPLE 17

To obtain the recording layer medium we prepared the ethanol and ethyl cellosolve mixture solution (1:1), containing 1% nitrocellulose, 0.039% 3,3,3′3′tetramethyl-1,1′-diphenylindotricarbocyanine perchlorate and dioctylphthalate 0.2%. The compound solvent was filtered, deposited on a polycarbonate disc and dried to form a recording layer with 300 nm thickness.

### EXAMPLE 18

To obtain the recording layer medium we prepared the ethanol and ethyl cellosolve mixture solution (1:1), containing 1% nitrocellulose, 0.078% 3,3,3′3′tetramethyl-1,1′-diphenylindotricarbocyanine perchlorate and dioctylphthalate 0.2%. The compound solvent was filtered, deposited on a polycarbonate disc and dried to form a recording layer with 200 nm thickness.

### EXAMPLE 19

To obtain the recording layer medium we prepared the ethanol and ethyl cellosolve mixture solution (1:1), containing 1% nitrocellulose, 0.013% HITC (Exiton, Inc.) and dioctylphthalate 0.2%. The compound solvent was filtered, deposited on a polycarbonate disc and dried to form a recording layer with 400 nm thickness.

### EXAMPLE 20

To obtain the recording layer medium we prepared the ethanol and ethyl cellosolve mixture solution (1:1), containing 1% nitrocellulose, 0.039% HITC (Exiton, Inc.) and dioctylphthalate 0.2%. The compound solvent was filtered, deposited on a polycarbonate disc and dried to form a recording layer with 300 nm thickness.

### EXAMPLE 21

To obtain the recording layer medium we prepared the ethanol and ethyl cellosolve mixture solution (1:1), containing 1% nitrocellulose, 0.078% HITC (Exiton, Inc.) and dioctylphthalate 0.2%. The compound solvent was filtered, deposited on a polycarbonate disc and dried to form a recording layer with 300 nm thickness.

### EXAMPLE 22

To obtain the recording layer medium we prepared the ethanol and ethyl cellosolve mixture solution (1:1), containing 1% nitrocellulose, 0.013% 3,3,3′3′tetramethyl-1,1′-diphenyl-10,12-dimethylene-11-diphenylaminoindotricarbocyanine perchlorate and dioctylphthalate 0.2%. The compound solvent was filtered, deposited on a polycarbonate disc and dried to form a recording layer with 400 nm thickness.

### EXAMPLE 23

To obtain the recording layer medium we prepared the ethanol and ethyl cellosolve mixture solution (1:1), containing 1% polyvinylacetate, 0.039% 3,3,3′3′tetramethyl-1,1′diphenyl-10,12-dimethylene-11-diphenylaminoindotricarbocyanine perchlorate and dioctylphthalate 0.2%. The compound solvent was filtered, deposited on a polycarbonate disc and dried to form a recording layer with 500 nm thickness.

### EXAMPLE 24

To obtain the recording layer medium we prepared the ethanol and ethyl cellosolve mixture solution (1:1), containing 1% nitrocellulose, 0.078% 3,3,3′3′tetramethyl-1,1′-diphenyl-10,12-dimethylene-11-diphenylaminoindotricarbocyanine perchlorate and dioctylphthalate 0.2%. The compound solvent was filtered, deposited on a polycarbonate disc and dried to form a recording layer with 500 nm thickness.

### EXAMPLE 25

To obtain the recording layer medium we prepared the ethyl cellosolve solution (1:1), containing 0.5% polyvinylacetate and 0.5% nitrocellulose, 0.039% 3,3,3′3′tetramethyl-1,1′-diphenylindotricarbo-cyanine perchlorate and dioctylphthalate 0.2%. The compound solvent was filtered, deposited on a polycarbonate disc and dried to form a recording layer with 500 nm thickness.

### EXAMPLE 26

To obtain the recording layer medium we prepared the ethyl cellosolve solution (1:1), containing 0.5% polyvinylacetate and 0.5% nitrocellulose, 0.039% HIDC (Exciton, Inc.) and dioctylphthalate 0.2%. The compound solvent was filtered, deposited on a polycarbonate disc and dried to form a recording layer with 500 nm thickness. Every optical disc obtained according to examples 1-26 was placed on the rotating table and radiated by focused laser pulses of 1 ns duration, received from a semiconductor laser with 635, 650 or 830 nm wavelength, 10 mW power. For comparison, we took a standard CD-R disc by TDK with ablative recording and reflective reading. An optical microscope was use to follow physical and chemical changes of the layer after recording. This discovered decoloration of the dye on the studied examples on the irradiated spots. As a result, fluorescent signal intensity the recorded spots lowered, while the background fluorescence did not change. The observation showed no change in the geometrical structure of the recording layer. Under the same conditions, the standard CD-R disc was ablatively recorded by thermoperforation. The signal-to-noise ratio on the studied examples was higher than on the CD-R disc and equal to 3-5.

### References

1. Principles of Optical Discs Systems G. Bouwhnis, J. Braat, A. Huijser et.al., Philips Research Laboratories, Einhoven, Adam Hilder Ltd, 1985.

2. A. S. Dvornikov, P. M. Rentzepis, Opt. Comms., v.136, pp.1-6, 1997.

3. B. Glushko, U.S. Provisional Application, May 8, 1997, N. 25457.

4. E. Ott., Cellulose and cellulose derivatives, pt. 2, N.Y. -L., 1954, p.746.

1-8. cancel.

9. An optical recording medium for a fluorescent WORM disc for having information recorded thereon by recording laser radiation, the medium comprising:
(a) a fluorescent dye, capable of absorbing the recording laser radiation and transforming the absorbed recording laser radiation into heat;
(b) a nitrocellulose for generating decomposition products under heating, which provides or causes an extinguishing of a dye fluorescence of the fluorescent dye; and
(c) a film-forming polymer with high transparency, low heat conductivity and providing a necessary quantum output of dye fluorescence;
said medium comprising said fluorescent dye in such a concentration that said medium has both sufficient fluorescence and sufficient transparency for said multilayer fluorescent WORM disc.

10. The medium of claim 9, wherein the fluorescent dye is chosen from xanthene dyes of the eosine and rhodamine groups, acridine, oxazine, azine, perylene, violanthrone, cyanine, phthalocyanine dyes, indigoide colors and porphyrines, and wherein a content of the fluorescent dye in the recording layer is equal to 0.1-10%.

11. The medium of claim 9, wherein the nitrocellulose comprises 10.7 up to 12.5% nitrogen and has a polymerization rate characterized by a nitrocellulose macromolecule with a number of etherified glucose residues in said nitrocellulose macromolecule within a range of 150-300, and wherein a nitrocellulose content in the recording layer is 10-80%.

12. The medium of claim 9, wherein the film-forming polymer is chosen from the group consisting of cellulose ethers, vinyl resins, acrylic resins, other resins, and mixtures thereof.

13. The medium of claim 9, wherein the medium further comprises a plasticizer chosen from the group consisting of phthalates and phosphates, and wherein a content of the plasticizer in the medium is 10-50%.

14. The medium of claim 9, wherein the fluorescent dye generates non-fluorescent dimers, which absorb the recording laser radiation and transform the absorbed light power into the heat, and wherein a fluorescent monomer form of the dye absorbs a wavelength of a reading laser used to read the WORM disc.

15. A method of obtaining a multilayer optical WORM disc for having information recorded on said multilayer optical WORM disc by recording laser radiation, said method comprising:
(a) preparing an optical recording medium comprising:
(i) a fluorescent dye, capable of absorbing the recording laser radiation and transforming the absorbed recording laser radiation into heat;
(ii) a nitrocellulose for generating decomposition products under heating, which provide or cause an extinguishing of a dye fluorescence of the fluorescent dye; and
(iii) a film-forming polymer with high transparency, low heat conductivity and providing a necessary quantum output of dye fluorescence;
(b) forming the optical recording medium prepared in step (a) into a plurality of single-layer discs, each of the plurality of single-layer discs having a recording layer; and
(c) consecutive bonding of the single-layer discs one to another forming the multilayer optical WORM disc with two and more of said recording layers, in which the two or more of said recording layers alternate with substrate layers.

16. The method of claim 15, wherein step (a) comprises dissolving the fluorescent dye, the nitrocellulose, and the film-forming polymer in an organic solvent.

17. The method of claim 16, wherein the organic solvent is chosen from the group consisting of alcohols, ketones, amides, sulfoxides, ethers, esters, halogenated aliphatic hydrocarbons, and aromatic solvents.

18. The method of claim 15, wherein step (a) comprises introducing the fluorescent dye, the nitrocellulose and the film-forming polymer into an organic solvent as microcapsules less than 0.2 μm in size.

19. The method of claim 18, wherein step (b) comprises applying the organic solvent with the microcapsules introduced into the organic solvent onto a substrate by spin coating, roller coating or dip coating on the substrate.

20. The method of claim 19, wherein the substrate is a glass, polymethylmethacrylate, polycarbonate or polyethylene terephthalate disc.

21. A multilayer optical WORM disc for having information recorded thereon by recording laser radiation, said multilayer optical WORM disc comprising:
(a) a plurality of recording layers comprising an optical recording medium, the optical recording medium comprising:
(i) a fluorescent dye, capable of absorbing the recording laser radiation and transforming the absorbed recording laser radiation into heat;
(ii) a nitrocellulose for generating decomposition products under heating, which provide or cause an extinguishing of a dye fluorescence of the fluorescent dye; and
(iii) a film-forming polymer with high transparency, low heat conductivity and providing a necessary quantum output of dye fluorescence; and
(b) a plurality of substrate layers alternating with the plurality of recording layers.

22. The disc of claim 21, wherein the fluorescent dye is chosen from xanthene dyes of the eosine and rhodamine groups, acridine, oxazine, azine, perylene, violanthrone, cyanine, phthalocyanine dyes, indigoide colors and porphyrines, and wherein a content of the fluorescent dye in each of the recording layers is equal to 0.1-10%.

23. The disc of claim 21, wherein the nitrocellulose comprises 10.7 up to 12.5% nitrogen and has a polymerization rate characterized by a nitrocellulose macromolecule with a number of etherified glucose residues in said nitrocellulose macromolcule within a range of 150-300, and wherein a nitrocellulose content in the recording layer is 10-80%.

24. The disc of claim 21, wherein the film-making polymer is chosen from the group consisting of cellulose ethers, vinyl resins, acrylic resins, other resins, and a mixture of these substances.

25. The disc of claim 21, wherein the medium further comprises a plasticizer chosen from the group consisting of phthalates and phosphates, and wherein a content of the plasticizer in the medium is 10-50%.

26. The disc of claim 21, wherein the fluorescent dye generates non-fluorescent dimers, which absorb the recording laser radiation and transform the absorbed light power into the heat, and wherein a fluorescent monomer form of the dye absorbs a wavelength of a reading laser used to read the WORM disc.

27. An optical recording medium for a fluorescent WORM disc for having information recorded thereon by recording laser radiation, the medium comprising:
(a) a fluorescent dye, wherein the fluorescent dye generates non-fluorescent dimers, which absorb the recording laser radiation and transform the absorbed light power into the heat, and wherein a fluorescent monomer form of the dye absorbs a wavelength of a reading laser used to read the WORM disc;
(b) a nitrocellulose for generating decomposition products under heating, which provides or causes an extinguishing of a dye fluorescence of the fluorescent dye, wherein the nitrocellulose comprises 10.7 up to 12.5% nitrogen and has a polymerization rate characterized by a nitrocellulose macromolecule with a number of etherified glucose residues in said nitrocellulose macromolecule within a range of 150-300, and wherein a nitrocellulose content in the recording layer is 10-80%;
(c) a film-forming selected from the group consisting of cellulose ethers, vinyl resins, acrylic resins, other resins, and mixtures thereof; and
(d) a plasticizer chosen from the group consisting of phthalates and phosphates, and wherein a content of the plasticizer in the medium is 10-50%;
said medium comprising said fluorescent dye in such a concentration that said medium has both sufficient fluorescence and sufficient transparency for said multilayer fluorescent WORM disc.
